(19) United States
(12) Patent Application Publication
(10) Pub. No.: US 2023/0042747 A1
(43) Pub. Date: Feb. 9, 2023

(54) Message Processing Method and Device, Storage Medium, and Electronic Device

(71) Applicant: SUZHOU CENTEC COMMUNICATIONS CO., LTD., Suzhou, Jiangsu (CN)

(72) Inventors: Zhichuan HE, Suzhou, Jiangsu (CN); Jie ZHOU, Suzhou, Jiangsu (CN); Chao QIAN, Suzhou, Jiangsu (CN)

(21) Appl. No.: 17/789,224

(22) PCT Filed: Sep. 2, 2020
(86) PCT No.: PCT/CN2020/113079

§ 371 Date: Jun. 27, 2022

(30) Foreign Application Priority Data
Dec. 27, 2019 (CN) 201911380640.9

(51) Int. Cl. H04L 43/10; H04L 49/00; H04L 69/22

(52) U.S. Cl. CPC H04L 43/10; H04L 49/3036; H04L 69/22

(57) ABSTRACT

A message processing method and device, a storage medium, and an electronic device are provided. The method includes: acquiring a first message sent by an Ingress Process Engine (IPE) of a switch, and acquiring a second message sent by an Egress Process Engine (EPE) of the switch, a header of the first message includes data collected by an Inband Network Telemetry (INT), and the first message is the same as the second message; identifying the first message and the second message as a same message stream according to key information of a message header; and combining and reorganizing the first message and the second message identified as the same message stream into an INT report, and sending the INT report to a target device. The problem in the related art that network state monitoring at a protocol layer consumes a large amount of network bandwidth is solved.

The present disclosure is a national stage filing of PCT Application No. PCT/CN2020/113079 filed on Sep. 2, 2020, which claims priority to Chinese patent application No. 201911380640.9, filed on Dec. 27, 2019, and entitled “message processing method and device, storage medium, and electronic device”, the contents of which are hereby incorporated by reference in its entirety.

### TECHNICAL FIELD

The present disclosure relates to the field of computers, and in particular, to a message processing method and device, a storage medium, and an electronic device.

### BACKGROUND

Traditional network state monitoring is usually implemented at a protocol layer. That is, an instruction of collecting a network state is issued to a switch via a protocol, and the switch returns the state thereof to a monitoring device. This method not only consumes a large amount of network bandwidth, but also causes the risk of network congestion.

Aiming at the above problems in the related art, no effective solution currently exists.

### SUMMARY

Embodiments of the present disclosure provide a message processing method and device, a storage medium, and an electronic device, intended to solve the problem in the related art that network state monitoring at a protocol layer consumes a large amount of network bandwidth.

According to one embodiment of the present disclosure, a message processing method is provided, which may include the following operations. A first message sent by an Ingress Process Engine (IPE) of a switch is acquired, and a second message sent by an Egress Process Engine (EPE) of the switch is acquired. A header of the first message includes data collected by an Inband Network Telemetry (INT), and the first message is the same as the second message. The first message and the second message are identified as a same message stream according to key information of a message header. The first message and the second message identified as the same message stream are combined and reorganized into an INT report, and the INT report is sent to the target device.

According to another embodiment of the present disclosure, a message processing device is provided, which may include: an acquisition module, configured to acquire a first message sent by an IPE of a switch, and acquire a second message sent by an EPE of the switch, a header of the first message includes data collected by an INT, and the first message is the same as the second message; an identification module, configured to identify the first message and the second message as the same message stream according to key information of a message header; and a sending module, configured to combine and reorganize the first message and the second message identified as a same message stream into an INT report, and send the INT report to a target device.

According to yet another embodiment of the present disclosure, a storage medium is also provided. The storage medium may store a computer program therein which, when run, is configured to perform the steps in any one of the above method embodiments.

According to yet another embodiment of the present disclosure, an electronic device is also provided, which may include a memory and a processor. The memory stores a computer program. The processor is configured to run the computer program to perform the steps in any one of the above method embodiments.

By means of the present disclosure, a first message sent by an IPE of a switch is acquired, and a second message sent by an EPE of the switch is acquired. Then, the first message and the second message are identified as the same message stream according to key information of a message header. Finally, the first message and the second message identified as the same message stream are combined and reorganized into an INT report, and the INT report is sent to a target device. It can be seen that the function of an INT Sink node can be realized without inserting INT information of a current switch into a message, thereby solving the problem in the related art that network state monitoring at a protocol layer consumes a large amount of network bandwidth, and reducing the consumption of network bandwidth.

### BRIEF DESCRIPTION OF THE DRAWINGS

The accompanying drawings described herein are used to provide a further understanding of the present disclosure, and constitute a part of the present application, and the exemplary embodiments of the present disclosure and the description thereof are used to explain the present disclosure, but do not constitute improper limitations to the present disclosure. In the drawings:

FIG. 1 is a block diagram of a hardware structure of a terminal of a message processing method according to an embodiment of the present disclosure;

FIG. 2 is a flowchart of a message processing method according to an embodiment of the present disclosure;

FIG. 3 is a schematic diagram of a chip implementation method of an INT Sink node according to an embodiment of the present disclosure;

FIG. 4 is a schematic structure diagram of a bus for chip internal message forwarding according to an embodiment of the present disclosure; and

FIG. 5 is a structural block diagram of a message processing device according to an embodiment of the present disclosure.

### DETAILED DESCRIPTION OF THE EMBODIMENTS

The present disclosure is described below with reference to the drawings and in conjunction with the embodiments in detail. It should be noted that embodiments in the present application and features in the embodiments may be combined under the condition of no conflicts.

It should be noted that the specification and claims of the present disclosure and the terms “first”, “second” and the like in the drawings are used for distinguishing between similar objects and not necessarily for describing a particular sequential or chronological order.

It should be noted that an INT is a network architecture, which can realize the functions of collecting a data layer and reporting a network state without the interference of a control layer. In an INT architecture model, a message contains an INT Header, which can be understood as a “telemetry instruction” issued by a network device. These instructions inform online network devices to insert relevant information needing to be collected by the INT into a message passing through an INT node.

One of INT domains contains three node devices, i.e. a source node, a transmit node and a sink node. The INT source node is a network device for inserting a telemetry instruction into a data message. The INT transmit node is a network device responsible for inserting relevant information about this node into a data message according to a telemetry instruction. The INT sink node is a network device for sending an INT report to a target device and de-encapsulating an INT message. The INT report sent by the INT sink node needs to contain relevant information about this node.

### Embodiment 1

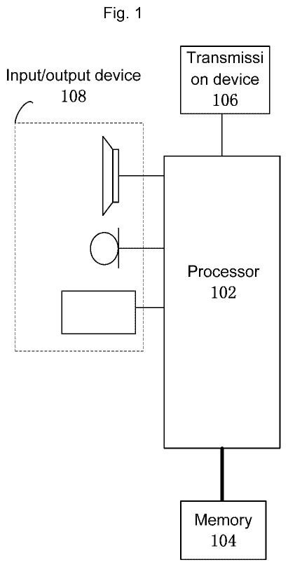

The method embodiment provided by Embodiment 1 of the present application may be implemented in a terminal, a computer terminal or a similar computing device. Running on a terminal is taken as an example. FIG. 1 is a block diagram of a hardware structure of a terminal of a message processing method according to an embodiment of the present disclosure. As shown in FIG. 1, a terminal 10 may include one or more (only one is shown in FIG. 1) processors 102 (the processor 102 may include but is not limited to a processing apparatus such as a Micro Controller Unit (MCU) or a Field Programmable Gate Array (FPGA)) and a memory 104 for storing data. Optionally, the above terminal may further include a transmission device 106 and an input/output device 108 for communication functions. Those of ordinary skill in the art can understand that the structure shown in FIG. 1 is merely illustrative, and does not limit the structure of the above terminal. For example, the terminal 10 may also include more or fewer components than shown in FIG. 1, or has a different configuration from that shown in FIG. 1.

The memory 104 may be configured to store a computer program, for example, a software program and module of application software, such as a computer program corresponding to the message processing method in the embodiment of the present disclosure, and the processor 102 executes various functional applications and data processing by running the computer program stored in the memory 104, that is, implements the above method. The memory 104 may include a high speed random access memory and may also include a non-volatile memory such as one or more magnetic storage devices, a flash memory, or other non-volatile solid state memories. In some examples, the memory 104 may further include memories remotely located relative to the processor 102, which may be connected to the terminal 10 over a network. The examples of such networks include, but are not limited to, the Internet, the Intranet, local area networks, mobile communication networks, and combinations thereof.

The transmission device 106 is configured to receive or send data via a network. The above specific network example may include a wireless network provided by a communication provider of the terminal 10. In one example, the transmission device 106 includes a Network Interface Controller (NIC) that may be connected to other network devices through a base station to communicate with the Internet. In one example, the transmission device 106 may be a Radio Frequency (RF) module for communicating with the Internet wirelessly.

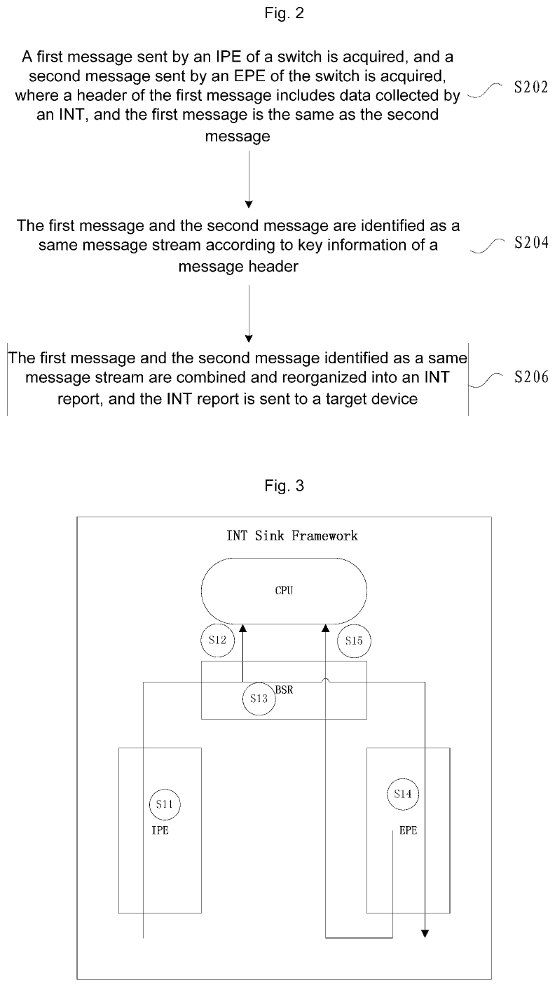

In the present embodiment, a message processing method running on the above terminal is provided. FIG. 2 is a flowchart of a message processing method according to an embodiment of the present disclosure. As shown in FIG. 2, the flow includes the following steps.

In step S202, a first message sent by an IPE of a switch is acquired, and a second message sent by an EPE of the switch is acquired. A header of the first message includes data collected by an INT, and the first message is the same as the second message.

It should be noted that INT collection data in the present embodiment may be Source node and Transit node data in a specific application scenario, and the second message includes collected Sink node data in a chip Bridge Header.

In step S204, the first message and the second message are identified as a same message stream according to key information of a message header.

In step S206, the first message and the second message identified as the same message stream are combined and reorganized into an INT report, and the INT report is sent to a target device.

By means of the above-mentioned steps S202 to S206, a first message sent by an IPE of a switch is acquired, and a second message sent by an EPE of the switch is acquired. Then, the first message and the second message are identified as the same message stream according to key information of a message header. Finally, the first message and the second message identified as the same message stream are combined and reorganized into an INT report, and the INT report is sent to a target device. It can be seen that the function of an INT Sink node can be realized without inserting INT information of a current switch into a message, thereby solving the problem in the related art that network state monitoring at a protocol layer consumes a large amount of network bandwidth, and reducing the consumption of network bandwidth.

It should be noted that the main execution body of the method steps in the present embodiment may be a chip, such as an Application Specific Integrated Circuit (ASIC) chip, or an FPGA chip, or an NP, etc. and may be adjusted accordingly according to actual situations.

In an optional implementation of the present embodiment, the manner of acquiring a first message sent by an IPE of a switch involved in step S202 may further include the following operations. The first message forwarded by the IPE to a BSR is acquired. After receiving the first message, the BSR copies the first message and forwards the copied first message to the EPE.

In an optional implementation of the present embodiment, the manner of acquiring a second message sent by an EPE of the switch involved in step S202 may further include the following operations. The second message forwarded by the EPE to the BSR is acquired. After receiving the second message, the BSR copies the second message and forwards the copied second message to the EPE.

In the above-mentioned step S202, the manner of acquiring the first message and the second message is executed, e.g., by a chip in a specific application scenario. The first message will be forwarded to a processor of the chip by the BSR after being forwarded to the BSR, and the BSR will copy a first message and forward the first message to the EPE.

It should be noted that the key information of the message header in the present embodiment includes: an ingress port, an ingress timestamp and a quintuple. In a specific application scenario, the ingress port, the ingress timestamp and the quintuple in the message information are carried in a Bridge Header.

In an optional implementation of the present embodiment, the manner of identifying the first message and the second message as the same message stream according to message information involved in step S204 may further include the following steps.

In step S204-11, a first hash value is calculated according to the ingress port, the ingress timestamp and the quintuple in the first message.

In step S204-12, a second hash value is calculated according to the ingress port, the ingress timestamp and the quintuple in the second message. If the key information of the message header of the first message is the same as the key information of the message header carried in the second message, the first hash value is the same as the second hash value.

In step S204-13, the first message and the second message are identified as a same message stream according to the first hash value and the second hash value.

It can be seen from the above-mentioned steps S204-11 to S204-13 that the messages are identified as the same message stream by means of the hash values calculated according to the ingress port, the ingress timestamp and the quintuple in the key information of the message header. By calculating the hash values, it can be more accurate to identify whether the messages are the same message stream.

In the present embodiment, the manner of sending the first message and the second message identified as the same message stream to a target device involved in step S206 may further include the following operation. The first message and the second message identified as a same message stream are combined and reorganized into an INT report according to an INT message protocol, and the INT report is sent to a target device.

The following describes the present application in combination with optional implementations of the present embodiment.

In the present optional implementation, a chip implementation method for an INT Sink node is provided. As shown in FIG. 3, the method includes the following steps.

In step S11, a chip forwards a message to a BSR in an ingress direction of a switch.

Step S11 includes: receiving a message and parsing an INT message, judging whether INT Sink processing needs to be performed via a stream table, and sending the message to a CPU for information processing.

In step S12, the BSR copies a message to a CPU.

Step S12 may further include: collecting hash value information calculated according to an ingress port, an ingress timestamp and a quintuple to form a Bridge Header.

In step S13, the BSR forwards the message to an EPE.

Step S13 further includes: queue buffer and information forwarding.

In step S14, the EPE sends a message to the BSR and also forwards the message.

Step 4 further includes: de-encapsulating an INT message and sending the message to the CPU for information processing.

In step S15, the BSR copies a message to the CPU, and the CPU identifies two messages as the same stream according to the Hash value calculated according to the ingress port, the ingress timestamp and the quintuple in the Bridge Header, then forms a Report message according to an INT Report protocol, and sends the Report message to a monitoring device.

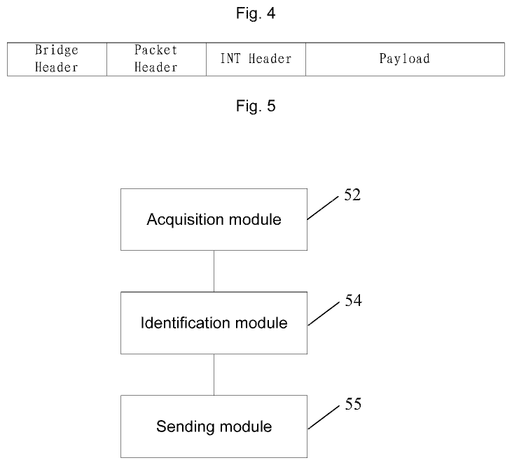

Step S15 further includes: collecting metadata of a current switch and forming a Bridge Header. A bus structure for chip internal message forwarding is shown in FIG. 4.

In the present optional implementation, the chip implements INT message de-encapsulating of a Sink node, and the CPU identifies two messages uploaded by the IPE and the EPE as the same stream according to the Hash value calculated according to the ingress port, the ingress timestamp and the quintuple in the Bridge Header, and sends a Report message to a monitoring device according to an INT Report protocol, so that the function of the INT Sink node can be realized.

Through the description of the above implementations, those skilled in the art may clearly understand that the method according to the above embodiment may be implemented by means of software and a necessary general hardware platform, and of course, may also be implemented through hardware, but in many cases, the former is a better implementation. Based on such understanding, the technical solution of the present disclosure, which is essential or contributes to the conventional art, may be embodied in the form of a software product stored in a storage medium (such as a Read-Only Memory (ROM)/RAM, a magnetic disk and an optical disc), including a number of instructions for causing a terminal device (which may be a mobile phone, a computer, a server, or a network device, etc.) to perform the methods described in various embodiments of the present disclosure.

### Embodiment 2

In the present embodiment, a message processing device is also provided, which is configured to implement the above embodiments and preferred implementations, and the description thereof has been omitted. As used below, the term “module” may implement a combination of software and/or hardware of a predetermined function. Although the apparatus described in the following embodiments is preferably implemented by software, hardware or a combination of software and hardware is also possible and conceived.

FIG. 5 is a schematic structure diagram of a message processing device according to an embodiment of the present disclosure. As shown in FIG. 5, the device includes an acquisition module 52, an identification module 54 and a sending module 56.

(1) The acquisition module 52 is configured to acquire a first message sent by an IPE of a switch, and acquire a second message sent by an EPE of the switch. A header of the first message includes data collected by an INT, and the first message is the same as the second message.

(2) The identification module 54 is configured to identify the first message and the second message as a same message stream according to key information of a message header.

(3) The sending module 56 is configured to combine and reorganize the first message and the second message identified as the same message stream into an INT report, and send the INT report to a target device.

Optionally, the acquisition module 52 in the present embodiment may further include: a first acquisition unit, configured to acquire the first message forwarded by the IPE to a BSR, where after receiving the first message, the BSR copies the first message and forwards the copied first message to the EPE; and a second acquisition unit, configured to acquire the second message forwarded by the EPE to the BSR, where after receiving the second message, the BSR copies the second message and forwards the copied second message to the EPE.

Optionally, the key information of the message header in the present embodiment further includes: an ingress port, an ingress timestamp and a quintuple.

Based on the key information of the message header, the identification module 54 in the present embodiment may further include: a first calculation unit, configured to calculate a first hash value according to the ingress port, the ingress timestamp and the quintuple in the first message; a second calculation unit, configured to calculate a second hash value according to the ingress port, the ingress timestamp and the quintuple in the second message, where if the key information of the message header of the first message is the same as the key information of the message header of the second message, the first hash value is the same as the second hash value; and an identification unit, configured to identify the first message and the second message as the same message stream according to the first hash value and the second hash value.

Optionally, the sending module 56 in the present embodiment is further configured to combine and reorganize the first message and the second message identified as a same message stream into an INT report according to an INT message protocol, and send the INT report to a target device.

It should be noted that the various modules may be implemented by software or hardware, and for the latter, it may be implemented by, but not limited to: the above-mentioned modules are all located in the same processor; alternatively, the various modules may be located in different processors in any combination.

### Embodiment 3

The embodiment of the present disclosure also provides a storage medium. The storage medium stores a computer program therein which, when run, is configured to perform the steps in any one of the above method embodiments.

Optionally, in the present embodiment, the storage medium may be configured to store the computer program for performing the following steps.

At S1, a first message sent by an IPE of a switch is acquired, and a second message sent by an EPE of the switch is acquired. A header of the first message includes data collected by an INT, and the first message is the same as the second message.

At S2, the first message and the second message are identified as a same message stream according to key information of a message header.

At S3, the first message and the second message identified as the same message stream are combined and reorganized into an INT report, and the INT report is sent to a target device.

Optionally, in the present embodiment, the storage medium may include, but is not limited to, various media capable of storing a computer program such as a U disk, a ROM, a RAM, a mobile hard disk, a magnetic disk or an optical disc.

An embodiment of the present disclosure also provides an electronic device, which includes a memory and a processor. The memory stores a computer program. The processor is configured to run the computer program to perform the steps in any one of the above method embodiments.

Optionally, the electronic device may further include a transmission device and an input/output device, where the transmission device is connected to the processor, and the input/output device is connected to the processor.

Optionally, in the present embodiment, the processor may be configured to perform the following steps through the computer program.

At S1, a first message sent by an IPE of a switch is acquired, and a second message sent by an EPE of the switch is acquired. A header of the first message includes data collected by an INT, and the first message is the same as the second message.

At S2, the first message and the second message are identified as the same message stream according to key information of a message header.

At S3, the first message and the second message identified as a same message stream are combined and reorganized into an INT report, and the INT report is sent to a target device.

Optionally, a specific example in the present embodiment may refer to the examples described in the above embodiments and optional implementations, and details are not described herein in the present embodiment.

It is apparent that those skilled in the art should understand that the above modules or steps of the present disclosure may be implemented by a general-purpose computing device, and they may be centralized on a single computing device or distributed on a network composed of multiple computing devices. They may be implemented with program codes executable by a computing device, so that they may be stored in a storage device and executed by the computing device, and in some cases, the steps shown or described may be performed in a different order than here, or they are separately made into individual integrated circuit modules, or multiple modules or steps therein are made into a single integrated circuit module for implementation. As such, the present disclosure is not limited to any particular combination of hardware and software.

The above is only the preferred embodiments of the present disclosure, not intended to limit the present disclosure. As will occur to those skilled in the art, the present disclosure is susceptible to various modifications and changes. Any modifications, equivalent replacements, improvements and the like made within the principle of the present disclosure should fall within the protection scope of the present disclosure.

What is claimed is:

1. A message processing method, comprising:
acquiring a first message sent by an Ingress Process Engine (IPE) of a switch, and acquiring a second message sent by an Egress Process Engine (EPE) of the switch, wherein a header of the first message includes data collected by an Inband Network Telemetry (INT), and the first message is the same as the second message;
identifying the first message and the second message as a same message stream according to key information of a message header; and
combining and reorganizing the first message and the second message identified as the same message stream into an INT report, and sending the INT report to a target device.

2. The method according to claim 1, wherein
acquiring the first message sent by the IPE of the switch comprises: acquiring the first message forwarded by the IPE to a switch queue Buffer Store and Retrieve (BSR), wherein after receiving the first message, the BSR copies the first message and forwards the copied first message to the EPE; and
acquiring the second message sent by the EPE of the switch comprises: acquiring the second message forwarded by the EPE to the BSR, wherein after receiving the second message, the BSR copies the second message and forwards the copied second message to the EPE.

3. The method according to claim 1, wherein the key information of the message header comprises: an ingress port, an ingress timestamp and a quintuple.

4. The method according to claim 3, wherein identifying the first message and the second message as the same message stream according to the key information of the message header comprises:
calculating a first hash value according to the ingress port, the ingress timestamp and the quintuple in the first message;
calculating a second hash value according to the ingress port, the ingress timestamp and the quintuple in the second message, wherein in a case where the key information of the message header of the first message is the same as the key information of the message header of the second message, the first hash value is the same as the second hash value; and
identifying the first message and the second message as the same message stream according to the first hash value and the second hash value.

5. The method according to claim 1, wherein combining and reorganizing the first message and the second message identified as the same message stream into the INT report and sending the INT report to the target device comprises:
combining and reorganizing the first message and the second message identified as the same message stream into the INT report according to an INT message protocol, and sending the INT report to the target device.

6. A message processing device, comprising:
an acquisition module, configured to acquire a first message sent by an Ingress Process Engine (IPE) of a switch, and acquire a second message sent by an Egress Process Engine (EPE) of the switch, wherein a header of the first message includes data collected by an Inband Network Telemetry (INT), and the first message is the same as the second message;
an identification module, configured to identify the first message and the second message as a same message stream according to key information of the message header; and
a sending module, configured to combine and reorganize the first message and the second message identified as the same message stream into an INT report, and send the INT report to a target device.

7. The device according to claim 6, wherein the acquisition module comprises:
a first acquisition unit, configured to acquire the first message forwarded by the IPE to the switch queue Buffer Store and Retrieve (BSR), wherein after receiving the first message, the BSR copies the first message and forwards the copied first message to the EPE; and
a second acquisition unit, configured to acquire the second message forwarded by the EPE to the BSR, wherein after receiving the second message, the BSR copies the second message and forwards the copied second message to the EPE.

8. The device according to claim 6, wherein the key information of the message header comprises: an ingress port, an ingress timestamp and a quintuple.

9. The device according to claim 8, wherein the identification module comprises:
a first calculation unit, configured to calculate a first hash value according to the ingress port, the ingress timestamp and the quintuple in the first message;
a second calculation unit, configured to calculate a second hash value according to the ingress port, the ingress timestamp and the quintuple in the second message, wherein in a case where the key information of the header of the first message is the same as the key information of the header of the second message, the first hash value is the same as the second hash value; and
an identification unit, configured to identify the first message and the second message as the same message stream according to the first hash value and the second hash value.

10. The device according to claim 6, wherein
the sending module is further configured to combine and reorganize the first message and the second message identified as the same message stream into the INT report according to the INT message protocol, and send the INT report to the target device.

11. A computer-readable storage medium, storing a computer program therein which, when run, is configured to perform the method according to claim 1.

12. An electronic device, comprising a memory and a processor, wherein the memory stores a computer program, and the processor is configured to run the computer program to perform the method according to claim 1.

13. The method according to claim 2, wherein combining and reorganizing the first message and the second message identified as the same message stream into the INT report and sending the INT report to the target device comprises:
combining and reorganizing the first message and the second message identified as the same message stream into the INT report according to an INT message protocol, and sending the INT report to the target device.

14. The method according to claim 3, wherein combining and reorganizing the first message and the second message identified as the same message stream into the INT report and sending the INT report to the target device comprises:
combining and reorganizing the first message and the second message identified as the same message stream into the INT report according to an INT message protocol, and sending the INT report to the target device.

15. The method according to claim 4, wherein combining and reorganizing the first message and the second message identified as the same message stream into the INT report and sending the INT report to the target device comprises:
combining and reorganizing the first message and the second message identified as the same message stream into the INT report according to an INT message protocol, and sending the INT report to the target device.

16. The device according to claim 7, wherein
the sending module is further configured to combine and reorganize the first message and the second message identified as the same message stream into the INT report according to the INT message protocol, and send the INT report to the target device.

17. The device according to claim 8, wherein
the sending module is further configured to combine and reorganize the first message and the second message identified as the same message stream into the INT report according to the INT message protocol, and send the INT report to the target device.

18. The device according to claim 9, wherein
the sending module is further configured to combine and reorganize the first message and the second message identified as the same message stream into the INT report according to the INT message protocol, and send the INT report to the target device.

19. A computer-readable storage medium, storing a computer program therein which, when run, is configured to perform the method according to claim 2.

20. An electronic device, comprising a memory and a processor, wherein the memory stores a computer program, and the processor is configured to run the computer program to perform the method according to claim 2.
